(19) United States
(12) Patent Application Publication
(10) Pub. No.: US 2020/0167709 A1
(43) Pub. Date: May 28, 2020

(54) QUEUING SERVICE METHOD AND DEVICE AND STORAGE MEDIUM

(71) Applicant: BOE Technology Group Co., Ltd., Beijing (CN)

(72) Inventor: Baoyu Shi, Beijing (CN)

(21) Appl. No.: 16/524,616

(22) Filed: Jul. 29, 2019

(30) Foreign Application Priority Data
Nov. 23, 2018 (CN) 201811404204.6

(51) Int. Cl. G06Q 10/06; G06Q 10/10; H04W 4/024

(52) U.S. Cl. CPC G06Q 10/06316; H04W 4/024; G06Q 10/1097

(57) ABSTRACT

The present application proposes a queuing service method and device and a storage medium. The method includes: acquiring a first service number and a target service department of a target service object; acquiring information of each service personnel and a second service number of a service object who is being served in the target service department; determining a service waiting duration of the target service object according to the information of each service personnel, the first service number, and the second service number; and providing the service waiting duration to the target service object.

### CROSS-REFERENCE TO RELATED APPLICATION(S)

This application claims priority to the Chinese Patent Application No. CN201811404204.6, filed on Nov. 23, 2018, which is incorporated herein by reference in its entirety.

### TECHNICAL FIELD

The present application relates to the field of computer application technology, and more particularly, to a queuing service method, apparatus and device, and storage medium.

### BACKGROUND

For some hospitals with many departments and a complicated section distribution, since a patient is unfamiliar with a position distribution of a section for outpatients, visiting sections, and visiting waiting regions of each of the hospitals, as well as a specific visiting time, it is easy to cause the patient not to find a position of a visiting section after registration. Thereby, it may not only cause a delay in the visiting time, which in turn causes congestion in a region of the section for outpatients in the hospital, but also may easily lead to a long visiting waiting duration, reduce the visiting efficiency, and waste the patient's time.

In view of the above problems, a reception desk is usually deployed in a hall of the section for outpatients in the hospital and a large number of guide nurses are deployed to provide human consultation and hospital guide services to patients. However, this human hospital guide method not only fails to provide the patients with a specific visiting time, but also has a low service efficiency and a high operating cost.

### SUMMARY

According to a first aspect of the embodiments of the present application, there is provided a queuing service method, comprising:

acquiring a first service number and a target service department of a target service object;

acquiring information of each service personnel and a second service number of a service object who is being served in the target service department;

determining a service waiting duration of the target service object according to the information of each service personnel, the first service number, and the second service number; and

providing the service waiting duration to the target service object.

In an embodiment, the information of each service personnel is a historical service rate of the service personnel, and determining a service waiting duration of the target service object comprises:

calculating the service waiting duration of the target service object according to the historical service rate of the service personnel and a difference value between the first service number and the second service number.

In an embodiment, before determining the service waiting duration of the target service object, the method further comprises:

acquiring service data of each service personnel in a continuous time period, wherein the service data comprises a number of service objects, a service time of each of the service objects, and a service duration of each of the service objects; and

calculating, according to the service data of the service personnel in the continuous time period, the historical service rate of the service personnel in respective periods.

In an embodiment, determining the historical service rate of the service personnel in respective periods comprises:

determining an average service duration

$${T}_{x} = \frac{{\sum }_{i = 1}^{D} \frac{t}{{N}_{i}^{x}}}{D}$$

of each service object served by the service personnel in a period X,

where D is a number of service days of the service personnel in the continuous time period, i is an i^{th} service day in the continuous time period, Nᵢ^{X} is a number of service objects served by the service personnel in a period X of the i^{th} service day, and t is a duration of the period X.

In an embodiment, the method further comprises:

determining a recommended service waiting position of the target service object according to a number of service objects in each of service waiting regions and the service waiting duration of the target service object; and

providing the recommended service waiting position to the target service object.

In an embodiment, before determining the recommended service waiting position of the target service object, the method further comprises:

acquiring identity information of the target service object; and

determining a recommended service waiting position of the target service object comprises:

determining the recommended service waiting position of the target service object according to the identity information of the target service object, the number of service objects in each service waiting region, and the service waiting duration of the target service object.

In an embodiment, the method further comprises:

determining, according to a current position of the target service object, a position of the target service department and map data, a path along which the target service object moves from the current position to the target service department; and

providing, to the target service object, the path along which the target service object moves from the current position to the target service department.

In an embodiment, the method further comprises:

determining a service reminding time according to the path along which the target service object moves from the current position to the target service department and the service waiting duration of the target service object; and

transmitting a service reminder to the target service object at the service reminding time.

In an embodiment, determining a service reminding time comprises:

determining, according to the path along which the target service object moves from the current position to the target service department, a duration in which the target service object moves from the current position to the target service department, and determining a service time of the target service object according to the service waiting duration of the target object and a current time; and

determining the service reminding time according to the service time of the target service object and the duration in which the target service object moves from the current position to the target service department.

In an embodiment, determining the service waiting duration of the target service object comprises:

determining the service waiting duration of the target service object repeatedly at a preset period.

According to a second aspect of the embodiments of the present application, there is provided a queuing service device, comprising:

a processor; and

a memory connected to the processor, and has stored thereon instructions executed by the processor, wherein the instructions which, when executed by the processor, cause the processor to be configured to:
acquire a first service number and a target service department of a target service object;
acquire information of each service personnel and a second service number of a service object who is being served in the target service department;
determine a service waiting duration of the target service object according to the information of each service personnel, the first service number, and the second service number; and
provide the service waiting duration to the target service object.

In an embodiment, the processor is further configured to:

calculate the service waiting duration of the target service object according to the historical service rate of the service personnel and a difference value between the first service number and the second service number.

In an embodiment, the processor is further configured to:

acquire service data of each service personnel in a continuous time period, wherein the service data comprises a number of service objects, a service time of each of the service objects, and a service duration of each of the service objects; and

calculate, according to the service data of the service personnel in the continuous time period, the historical service rate of the service personnel in respective periods.

In an embodiment, the processor is further configured to:

determine an average service duration

$${T}_{x} = \frac{{\sum }_{i = 1}^{D} \frac{t}{{N}_{i}^{x}}}{D}$$

of each service object served by the service personnel in a period X,

where D is a number of service days of the service personnel in the continuous time period, i is an i^{th} service day in the continuous time period, Nᵢ^{X} is a number of service objects served by the service personnel in a period X of the i^{th} service day, and t is a duration of the period X.

In an embodiment, the processor is further configured to:

determine a recommended service waiting position of the target service object according to a number of service objects in each of service waiting regions and the service waiting duration of the target service object; and

provide the recommended service waiting position to the target service object.

In an embodiment, the processor is further configured to:

acquire identity information of the target service object; and

determine the recommended service waiting position of the target service object according to the identity information of the target service object, the number of service objects in each service waiting region, and the service waiting duration of the target service object.

In an embodiment, the processor is further configured to:

determine, according to a current position of the target service object, a position of the target service department and map data, a path along which the target service object moves from the current position to the target service department; and
provide, to the target service object, the path along which the target service object moves from the current position to the target service department.

In an embodiment, the processor is further configured to:

determine a service reminding time according to the path along which the target service object moves from the current position to the target service department and the service waiting duration of the target service object; and

transmit a service reminder to the target service object at the service reminding time.

In an embodiment, the processor is further configured to:

determine, according to the path along which the target service object moves from the current position to the target service department, a duration in which the target service object moves from the current position to the target service department, and determine a service time of the target service object according to the service waiting duration of the target object and a current time; and

determine the service reminding time according to the service time of the target service object and the duration in which the target service object moves from the current position to the target service department.

According to a third aspect of the embodiments of the present application, there is provided a computer readable storage medium having stored thereon a computer program, wherein the program, when executed by a processor, implements the queuing service method as described above.

Additional aspects and advantages of the present application will be set forth in part in the following description, will become apparent from the following description, or will be understood through the practice of the present application.

### BRIEF DESCRIPTION OF THE ACCOMPANYING DRAWINGS

The above and/or additional aspects and advantages of the present application will become apparent and readily understood from the description of the embodiments in conjunction with the accompanying drawings, in which:

FIG. 1 is a schematic flowchart of a queuing service method according to an embodiment of the present application;

FIG. 2 is a schematic flowchart of another queuing service method according to an embodiment of the present application;

FIG. 3 is a schematic structural diagram of a queuing service apparatus according to an embodiment of the present application; and

FIG. 4 is a schematic structural diagram of an electronic device according to an embodiment of the present application.

### DETAILED DESCRIPTION

The embodiments of the present application will be described in detail below, and examples of the embodiments are illustrated in the accompanying drawings, in which the same or similar reference numerals indicate the same or similar elements. The embodiments described below with reference to the accompanying drawings are intended to be illustrative, are intended to explain the present application, and are not to be construed as limiting the present application.

In view of the problem that the human hospital guide in a hospital not only fails to provide a specific visiting time to patients, but also has a low service efficiency and a high operating cost, the embodiments of the present application propose a queuing service method for hospital guide.

According to the queuing service method according to the embodiment of the present application, a first service number and a target service department of a target service object may be acquired; information of each service personnel on the day and a second service number of a service object who is being served in the target service department may be acquired; a service waiting duration of the target service object may be determined according to the information of each service personnel on the day, the first service number, and the second service number; and the service waiting duration may be provided to the target service object. Therefore, a patient who waits for visiting a doctor and his/her families in a hospital may clearly understand a specific visiting waiting duration and arrive at a visiting section in time, which not only reduces the visiting waiting duration and improves the visiting efficiency, but also saves human resources and operating costs of the hospital.

The queuing service method, apparatus and device, storage medium and computer program for hospital guide according to the present application will be described in detail below with reference to the accompanying drawings.

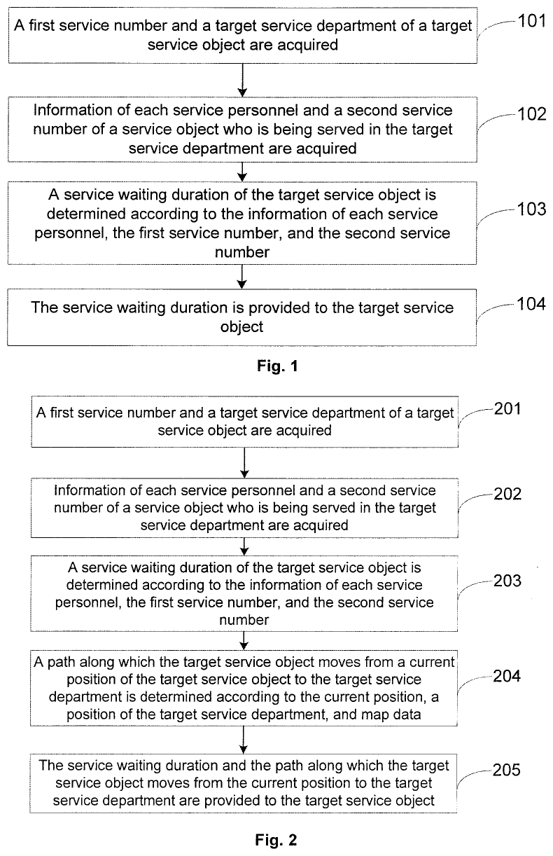

FIG. 1 is a schematic flowchart of a queuing service method according to an embodiment of the present application.

As shown in FIG. 1, the queuing service method comprises the following steps.

In step 101, a first service number and a target service department of a target service object are acquired. For example, a first visiting number and a name of a target visiting section of a target patient are acquired.

It should be illustrated that the queuing service method according to the embodiment of the present application may be performed by the queuing service apparatus according to the embodiment of the present application. The queuing service apparatus according to the embodiment of the present application may be disposed in any electronic device, such as a mobile phone, a tablet computer etc. Here, the first visiting number and the name of the target visiting section of the target patient may be provided to the queuing service apparatus through an input apparatus (a keyboard, a touch screen, etc.) of an electronic device after the target patient performs registration at a registration window or a self-service registration device in a hospital and acquires the first visiting number.

In a possible implementation of the embodiment of the present application, the queuing service method according to the embodiment of the present application may also implement a self-service registration function. Therefore, the first visiting number and the name of the target visiting section of the target patient may also be directly determined according to registration information of the target patient.

In step 102, information of each service personnel and a second service number of a service object who is being served in the target service department are acquired. For example, information of each doctor on the day and a second visiting number of a patient who is visiting a doctor in the target visiting section may be determined according to the name of the target visiting section.

In an embodiment, the information of the doctor may comprise a name, a job title, visiting data, a historical visiting rate etc. of the doctor. The historical visiting data of the doctor may be determined according to the visiting data of the doctor.

In the embodiment of the present application, after the first visiting number and the name of the target visiting section of the target patient are acquired, information of each doctor on the day which complies with the name of the target visiting section and the second visiting number of the patient who is visiting a doctor in the target visiting section may be determined according to the name of the target visiting section.

It should be illustrated that, in a possible implementation of the embodiment of the present application, a registration category of the target patient, such as an ordinary number and an expert number, may further be acquired, and then information of each doctor corresponding to the registration category in the target visiting section and a second visiting number of a patient who is visiting a doctor corresponding to the registration category in the target visiting section may be acquired.

For example, if the name of the target visiting section is “Orthopaedic” and the registration category of the target patient is an “ordinary number”, then information of each doctor on the day corresponding to the “ordinary number” in the “Orthopaedic” section and a second visiting number of a patient who is visiting a doctor corresponding to the “ordinary number” in the “Orthopaedic” section may be determined, without determining information of each doctor corresponding to an “expert number” and a second visiting number of a patient who is visiting a doctor corresponding to the “expert number” in the “Orthopaedic” section.

The above step 102 may further comprise:

acquiring service data of each service personnel in a continuous time period, wherein the service data comprises a number of service objects, a service time of each service object, and a service duration of each service object; and

calculating, according to the service data of the service personnel in the continuous time period, the historical service rate of the service personnel in respective periods.

In the embodiment of the present application, for example, visiting data of each doctor in a continuous time period is acquired, wherein the visiting data comprises a number of patients who visit the doctor, a visiting time of each patient who visits the doctor, and a visiting duration of each patient who visits the doctor; and then a historical visiting rate of the doctor in respective periods is determined according to the visiting data of the doctor in the continuous time period. Specifically, when the information of each doctor on the day in the target visiting section is determined, visiting data of the doctor may further be determined, to determine the visiting rate of the doctor according to the visiting data of the doctor. That is, in a possible implementation of the embodiment of the present application, the number of patients who visit a doctor refers to a number of all patients who visit a doctor in the target visiting section, and may be determined according to registration information of the target visiting section on the day. The visiting time of the patient who visits a doctor refers to a time when the patient starts to visit the doctor, and may be determined according to call information of the doctor, that is, a time when the doctor calls the visiting number of the patient who visits the doctor may be determined as the visiting time of the patient who visits the doctor. The visiting duration of the patient who visits a doctor may also be determined according to the call information of the doctor. That is, the visiting duration of the patient who visits a doctor may be determined according to a difference value between a time when the doctor calls a visiting number next to the visiting number of the patients who visit the doctor and a time when the doctor calls the visiting number of the patients who visit the doctor.

Here, the visiting data in the continuous time period refers to visiting data of each doctor on various visiting days in the continuous time period. The duration of the continuous time period may be preset according to practical requirements, which is not limited in the embodiment of the present application. For example, the duration may be one month, six months, one year etc., to improve the accuracy of the determined historical visiting rate of each doctor.

It should be illustrated that there may be a large difference in the number of patients who visit a doctor within respective periods in one day, that is, a peak visiting period and a valley visiting period may occur in one day, and a number of patients who visit a doctor in each period may also have an influence on the visiting rate of the doctor. Therefore, in a possible implementation of the embodiment of the present application, daily working hours of the doctor may be divided into a plurality of periods according to the daily working hours of the doctor, and then a historical visiting rate of each doctor in each period may be determined according to visiting data of the doctor in the period. That is, determining the historical visiting rate of each doctor in respective periods may comprise:

determining an average visiting duration

$${T}_{x} = \frac{{\sum }_{i = 1}^{D} \frac{t}{{N}_{i}^{x}}}{D}$$

of each patient who visits the doctor in a period X,

where D is a number of visiting days of the doctor in the continuous time period, i is an i^{th} visiting day in the continuous time period, Nᵢ^{X} is a number of patients who visit the doctor in a period X on the i^{th} visiting day, and t is a duration of the period X.

Actually, when the daily working hours of the doctors are divided into a plurality of periods, a duration of the periods may be preset according to practical requirements, which is not limited in the embodiment of the present application.

For example, if the daily working hours of the doctors are 8:00-17:00, and the duration of the periods may be preset to 1 hour, the determined plurality of periods are: 8:00-9:00, 9:00-10:00, 10:00-11:00, 11:00-12:00, 12:00-13:00, 13:00-14:00, 14:00-15:00, 15:00-16: 00 and 16:00-17:00.

In the embodiment of the present application, after the daily working hours of the doctors are divided into a plurality of periods, a number of patients who visit each doctor in each period on each visiting day in a continuous time period may be determined according to visiting data of the doctor in the period on the visiting day in the continuous time period. Specifically, a visiting end time of a patient who visits a doctor may firstly be determined according to a visiting time and a visiting duration of the patient who visits a doctor, and then a period to which the patient who visits a doctor belongs may be determined according to the visiting time and the visiting end time of the patient who visits a doctor. If the visiting time and the visiting end time of the patient who visits a doctor are both in the same period, the period may be determined as the period to which the patient belongs; and if the visiting time and the visiting end time of the patient who visits a doctor are in different periods, a period in which the visiting end time is located may be determined as the period to which the patient who visits a doctor belongs. For example, if a visiting time of a patient A who visits a doctor is 8:20, and a visiting end time of the patient A who visits a doctor is 8:25, a period to which the patient A who visits a doctor belongs is 8:00-9:00; and if a visiting time of a patient B who visits a doctor is 8:55, and a visiting end time of the patient B who visits a doctor is 9:05, a period to which the patient B who visits a doctor belongs is 9:00-10:00. After a period to which each patient who visits a doctor belongs is determined according to visiting data of the doctor, a number of patients who visit each doctor in each period may be counted.

In the embodiment of the present application, after the number of patients who visit each doctor in each period on a visiting day in a preset continuous time period is determined, a historical visiting rate of the doctor in each period may be determined according to a number of visiting days of the doctor in the preset continuous time period, a number of patients who visit the doctor in each period on the visiting day, and a duration of the period. Specifically, the historical visiting rate of each doctor in respective periods may be determined according to formula (1).

$${T}_{x} = \frac{{\sum }_{i = 1}^{D} \frac{t}{{N}_{i}^{x}}}{D} \qquad ( 1 )$$

where T_{X} is an average duration of treatment of a patient by a doctor in a period X, that is, a historical visiting rate of the doctor in the period X; D is a number of visiting days of the doctor in a preset continuous time period; i is an order of a visiting day in the continuous time period; Nᵢ^{X} is a number of patients who visit the doctor in a period X on an i^{th} visiting day; and t is a duration of the period.

For example, a duration t of the period is preset to 60 minutes, and a historical visiting rate of a doctor A in a period from 8:00 to 9:00 may be determined by formula (2).

$${T}_{8 , 9} = \frac{{\sum }_{i = 1}^{D} \frac{60}{{N}_{i}^{8 , 9}}}{D} \qquad ( 2 )$$

In step 103, a service waiting duration of the target service object is determined according to the information of each service personnel, the first service number, and the second service number. For example, a current visiting waiting duration of the target patient is determined according to the information of each doctor on the day, the first visiting number and the second visiting number.

In the embodiment of the present application, after the information of each doctor on the day corresponding to the target visiting section of the target patient and the second visiting number of the patient who is visiting a doctor in the target visiting section are determined, a current visiting waiting duration of the target patient may be determined according to the information of the doctor on the day, the first visiting number of the target patient, and the second visiting number of the patient who is visiting a doctor.

Specifically, the current visiting waiting duration of the target patient may be determined according to the historical visiting rate of each doctor on the day and a difference value between the first visiting number and the second visiting number. That is, in a possible implementation of the embodiment of the present application, the above step 103 may comprise:

calculating the service waiting duration of the target service object according to the historical service rate of the service personnel and a difference value between the first service number and the second service number. For example, the visiting waiting duration of the target patient is determined according to the historical visiting rate of each doctor on the day and the difference value between the first visiting number and the second visiting number.

It should be illustrated that the historical visiting rate of the doctor on the day in the target visiting section, who complies with the registration category of the target patient, in the current period may be determined according to a period in which the current time is located and the historical visiting rate of the doctor. If there are multiple doctors on the day in the target visiting section who comply with the registration category of the target patient, the visiting waiting duration of the target patient may be determined according to the average historical visiting rate of the multiple doctors in the current period and the difference value between the first visiting number and the second visiting number.

Specifically, the average historical visiting rate in the current period Y may be determined according to formula (3).

$${T}_{Y} = \frac{{\sum }_{j = 1}^{n} {T}_{Y}^{j}}{n} \qquad ( 3 )$$

where T_{Y} is the average historical visiting rate in the period Y, n is a number of doctors on the day in the target visiting section who comply with a registration category of a target patient who visits a doctor, j is an order of a doctor on the day in the target visiting section who complies with the registration category of the target patient who visits a doctor, and T_{Y}^{j} is a historical visiting rate of an j^{th} doctor in the period Y.

For example, if a duration of the period is preset to 60 minutes, the current period is 8:00-9:00, and the number of doctors on the day in the target visiting section who comply with the registration category of the target patient is 3, the historical visiting rate in the current period may be determined by equation (4).

$${T}_{8 , 9} = \frac{{\sum }_{j = 1}^{3} {T}_{8 , 9}^{i}}{3} \qquad ( 4 )$$

In the embodiment of the present application, after the average historical visiting rate of the doctor in the current period is determined, the current visiting waiting duration of the target patient may be determined according to the average historical visiting rate in the current period and the difference value between the first visiting number and the second visiting number. That is, the current visiting waiting duration of the target patient may be determined by formula (5).

T=(M−N)·T_{Y} (5)

where T is the current visiting waiting duration of the target patient, M is the first visiting number, N is the second visiting number, and T_{Y} is the average historical visiting rate in the current period Y.

Further, in order to enable a user to acquire the current visiting waiting duration in real time, the current visiting waiting duration of the target patient may be repeatedly determined at a certain time interval. That is, in a possible implementation of the embodiment of the present application, the above step 103 may comprise:

determining the visiting waiting duration of the target patient repeatedly at a preset period.

In the embodiment of the present application, the second visiting number of the patient who is visiting a doctor may be acquired at a preset period, and the historical visiting rate of the doctor in the target visiting section in the current period is determined according to the period in which the current time is located, so as to determine the current visiting waiting duration of the target patient.

It should be illustrated that the preset period may be a short time interval, for example, 5 minutes, to ensure the timeliness of the determined current visiting waiting duration, and prevent the user from missing the visiting time. In actual use, the period at which the visiting waiting duration of the target patient is repeatedly determined may be preset according to practical requirements, which is not limited in the embodiment of the present application.

In step 104, the service waiting duration is provided to the target service object. For example, the current visiting waiting duration is provided to the target patient.

In the embodiment of the present application, after the current visiting waiting duration of the target patient is determined, the determined visiting waiting duration may be provided to a terminal device of the target patient, so that the target patient may arrive at the target visiting section on time according to the current visiting waiting duration, to avoid missing the visiting time.

In the queuing service method for hospital guide according to the embodiment of the present application, the first visiting number and the name of the target visiting section of the target patient may be acquired, the information of each doctor on the day and the second visiting number of the patient who is visiting a doctor in the target visiting section may be determined, then the current visiting waiting duration of the target patient is determined according to the information of each doctor on the day, the first visiting number and the second visiting number, and then the current visiting waiting duration is synchronized to the target patient. Therefore, the current visiting waiting duration of the target patient is determined according to the information of the doctor corresponding to the target patient, the first visiting number of the target patient, and the second visiting number of the patient who is visiting a doctor, and is provided to the target patient, so that the patient may know a specific visiting waiting duration and arrive at the visiting section on time, which not only reduces the visiting waiting duration of the patient and improves the visiting efficiency, but also saves the human resources and operating costs of the hospital.

In a possible implementation of the present application, a path to the target visiting section may be planned for the target patient according to a current position of the target patient and a position of the target visiting section, so as to prevent the patient from missing the visiting time due to being unfamiliar with the section distribution of the hospital.

The queuing service method for hospital guide according to the embodiment of the present application will further be described below with reference to FIG. 2.

FIG. 2 is a schematic flowchart of another queuing service method according to an embodiment of the present application.

As shown in FIG. 2, the queuing service method comprises the following steps.

In step 201, a first service number and a target service department of a target service object are acquired.

In step 202, information of each service personnel and a second service number of a service object who is being served in the target service department are acquired.

Specific implementation processes and principle of the above steps 201-202 may be known with reference to the detailed description of the above embodiments, and will not be described in detail here.

In step 203, a service waiting duration of the target service object is determined according to the information of each service personnel, the first service number, and the second service number.

In the embodiment of the present application, after the information of each doctor on the day in the target visiting section, the first visiting number of the target patient, and the second visiting number of the patient who is visiting a doctor in the target visiting section are acquired, the current visiting waiting duration of the target patient may be determined according to the historical visiting rate of each doctor in the current period on the day, and the difference value between the first visiting number and the second visiting number.

Further, after the current visiting waiting duration of the target patient is determined, an appropriate visiting waiting position may be selected for the target patient according to the determined visiting waiting duration and a population intensity in each region. That is, in a possible implementation of the embodiment of the present application, after the above step 203, the method may further comprise:

determining a recommended service waiting position of the target service object according to a number of service objects in each service waiting region and the service waiting duration of the target service object; and

providing the recommended service waiting position to the target service object.

In the present embodiment, the recommended visiting waiting position of the target patient is determined, for example, according to the current number of personnel in each region of the hospital and the visiting waiting duration of the target patient; and the recommended visiting waiting position is provided to the target patient.

It should be illustrated that, in the embodiment of the present application, the current number of personnel in each region of the hospital may be acquired in real time using the wireless positioning technology and the video monitoring technology, and a visiting waiting position of the target visiting section, at which there is a small number of personnel and the target patient may arrive within the visiting waiting duration, is selected as the recommended visiting waiting position of the target patient. Thereby, not only the target patient may have a good rest in the visiting waiting duration, but also a crowd in the hospital may be alleviated and a population distribution in various regions of the hospital is balanced.

Further, for some special groups, such as elderly, children, pregnant women, etc., a visiting waiting position close to the target visiting section may firstly be selected as the recommended visiting waiting position. That is, in a possible implementation of the embodiment of the present application, after the above step 203, the method may further comprise:

acquiring identity information of the target service object; and

determining the recommended service waiting position of the target service object according to the identity information of the target service object, the number of service objects in each service waiting region, and the service waiting duration of the target service object.

In the present embodiment, the identity information of the target patient is acquired; and the recommended visiting waiting position of the target patient is determined according to the identity information of the target patient, the current number of personnel in each region of the hospital, and the visiting waiting duration of the target patient. Here, the identity information of the target patient may comprise a gender, an age, a symptom etc. of the target patient.

In a possible implementation of the embodiment of the present application, the identity information of the target patient may be determined according to registered information or registration information of the target patient, and it is determined whether the target patient belongs to a preset special group according to the identity information of the target patient, and if so, a visiting waiting position closest to the target visiting section may be determined as a recommended visiting waiting position of the target patient according to the current number of personnel in each region of the hospital and the visiting waiting duration of the target patient.

It should be illustrated that, in actual use, the identity information of the special group may be preset according to practical requirements, and will not be limited in the embodiment of the present application. For example, the identity information may be “an age less than 10 years old, or greater than 60 years old, or a pregnant woman” etc.

In step 204, a path along which the target service object moves from a current position of the target service object to the target service department is determined according to the current position, a position of the target service department, and map data. For example, a path along which the target patient moves from a current position of the target patient to the target visiting section is determined according to the current position, a position of the target visiting section, and map data of the hospital.

In the embodiment of the present application, after the target visiting section of the target patient is determined, a current position of the target patient may be acquired using a Global Positioning System (GPS) in the electronic device of the target patient, a position of the target visiting section is acquired according to map data of the hospital, and then a path along which the target patient moves from the current position of the target patient to the target visiting section is determined according to the current position, the position of the target visiting section, and the map data of the hospital, to prevent the user from missing the visiting time due to being unfamiliar with the section distribution of the hospital.

Further, after the path along which the target patient moves from the current position to the target visiting section is determined, a duration required for the target patient to move to the target visiting section may further be estimated according to a distance of the determined path, and the target patient is reminded in time to arrive at the target visiting section on time. That is, in a possible implementation of the embodiment of the present application, after the above step 204, the method may further comprise:

determining a service reminding time according to the path along which the target service object moves from the current position to the target service department and the service waiting duration of the target service object; and

transmitting a service reminder to the target service object at the service reminding time.

For example, a visiting reminding time is determined according to the path along which the target patient moves from the current position to the target visiting section and the current visiting waiting duration of the target patient; and a visiting reminder is transmitted to the target patient at the visiting reminding time.

Specifically, determining the visiting reminding time may comprise:

determining, according to the path along which the target patient moves from the current position to the target visiting section, a duration in which the target patient moves from the current position to the target visiting section;

determining a visiting time of the target patient according to the current visiting waiting duration of the target patient and the current time; and

determining the visiting reminding time according to the visiting time of the target patient and the duration in which the target patient moves from the current position to the target visiting section.

It may be understood that, after the path along which the target patient moves from the current position to the target visiting section is determined, the duration in which the target patient moves from the current position to the target visiting section may be estimated according to the determined moving path, then the current visiting time of the target patient is determined according to the current visiting waiting duration of the target patient, then the visiting reminding time is determined according to the duration required for the target patient to move from the current position to the target visiting section and the current visiting time, and visiting reminding information is transmitted to the target patient at the arrival of the visiting reminding time, so that the target patient who visits a doctor may arrive at the target visiting section before the arrival of the visiting time.

For example, if the duration required for the target patient to move from the current position to the target visiting section is 5 minutes, and the current visiting time of the target patient is determined to be 10:00 according to the current visiting waiting duration of the target patient, 9:55 may be determined as the visiting reminding time, and a visiting reminder may be transmitted to the target patient at 9:55.

In a possible implementation of the embodiment of the present application, an advance amount of the visiting reminding time may be preset automatically or according to an instruction input by the target patient, and the target patient is reminded in time of the upcoming arrival of the visiting time to ensure that the target patient may arrive at the target visiting section on time or in advance.

For example, if the preset advance amount of the visiting reminding time is 5 minutes, the duration required for the target patient to move from the current position to the target visiting section is 5 minutes, and the current visiting time of the target patient is determined as 10:00 according to the current visiting waiting duration of the target patient, 9:50 may be determined as the visiting reminding time, and a visiting reminder may be transmitted to the target patient at 9:50.

It should be illustrated that the above examples are merely exemplary and are not to be considered as limiting the present application. In actual use, the advance amount of the visiting reminding time may be preset according to practical requirements, and is not limited in the embodiment of the present application.

In step 205, the service waiting duration and the path along which the target service object moves from the current position to the target service department are provided to the target service object. For example, the current visiting waiting duration and the path along which the target patient moves from the current position to the target visiting section are provided to the target patient.

In the embodiment of the present application, after the current visiting waiting duration of the target patient and the path along which the target patient moves from the current position to the target visiting section are determined, the current visiting waiting duration and the path along which the target patient moves from the current position to the target visiting section may be provided to the electronic device of the target patient, so that the target patient may reasonably arrange activities in the period according to the visiting waiting duration, and arrive at the target visiting section on time according to the planned path from the current position to the target visiting section.

In the queuing service method for hospital guide according to the embodiment of the present application, the first visiting number of the target patient and the name of the target visiting section may be acquired, the information of each doctor on the day and the second visiting number of the patient who is visiting a doctor in the target visiting section may be determined according to the name of the target visiting section, then the current visiting waiting duration of the target patient may be determined according to the information of each doctor on the day, the first visiting number and the second visiting number, then the path along which the target patient moves from the current position of the target patient to the target visiting section may be determined according to the current position, the position of the target visiting section and the map data of the hospital, and thereby the current visiting waiting duration and the path along which the target patient moves from the current position to the target visiting section may be provided to the target patient. Therefore, the current visiting waiting duration of the target patient and the path along which the target patient moves to the target visiting section are determined according to visiting information such as the visiting number, the target visiting section, and the current position etc. of the target patient, and are provided to the target patient, so that the target patient may know the specific visiting waiting duration and the path to the target visiting section, and arrive at the visiting section on time, which not only reduces the visiting waiting duration of the patient and further improves the visiting efficiency, but also saves the human resources and operating costs of the hospital.

In order to implement the above embodiments, the present application further proposes a queuing service apparatus for hospital guide.

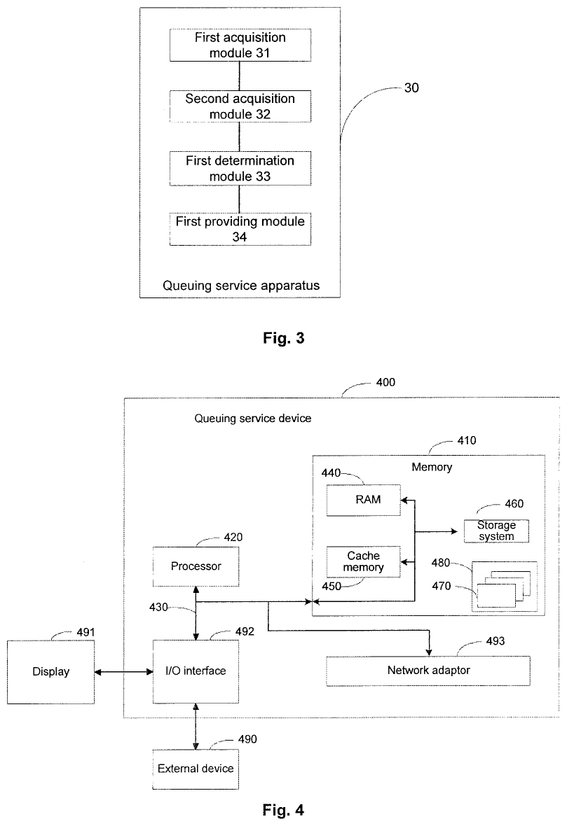

FIG. 3 is a schematic structural diagram of a queuing service apparatus according to an embodiment of the present application.

As shown in FIG. 3, the queuing service apparatus 30 comprises:

a first acquisition module 31 configured to acquire a first service number and a target service department of a target service object;

a second acquisition module 32 configured to acquire information of each service personnel and a second service number of a service object who is being served in the target service department;

a first determination module 33 configured to determine a service waiting duration of the target service object according to the information of each service personnel, the first service number, and the second service number; and

a first providing module 34 configured to provide the service waiting duration to the target service object.

In actual use, the queuing service apparatus according to the embodiment of the present application may be disposed in an electronic device to perform the above queuing service method.

In the queuing service apparatus according to the embodiment of the present application, the first visiting number and the name of the target visiting section of the target patient may be acquired, the information of each doctor on the day and the second visiting number of the patient who is visiting a doctor in the target visiting section may be determined according to the name of the target visiting section, then the current visiting waiting duration of the target patient may be determined according to the information of each doctor on the day, the first visiting number and the second visiting number, and then the current visiting waiting duration may be provided to the target patient. Therefore, the current visiting waiting duration of the target patient is determined according to information of a doctor corresponding to the target patient, the first visiting number of the target patient, and the second visiting number of the patient who is visiting a doctor, and is provided to the target patient, so that the target patient may know the specific visiting waiting duration and arrive at the visiting section on time, which not only reduces the visiting waiting duration of the patient and improves the visiting efficiency, but also saves the human resources and operating costs of the hospital.

In a possible implementation of the present application, the queuing service apparatus 30 further comprises:

a second determination module configured to determine a recommended service waiting position of the target service object according to a number of service objects in each service waiting region and the service waiting duration of the target service object; and

a second providing module configured to provide the recommended service waiting position to the target service object.

Further, in another possible implementation of the present application, the queuing service apparatus 30 further comprises:

a third acquisition module configured to acquire identity information of the target service object; and

correspondingly, the second determination module is specifically configured to:

determine the recommended service waiting position of the target service object according to the identity information of the target service object, the number of service objects in each service waiting region, and the service waiting duration of the target service object.

Further, in a further possible implementation of the present application, the queuing service apparatus 30 further comprises:

a third determination module configured to determine, according to a current position of the target service object, a position of the target service department, and map data, a path along which the target service object moves from the current position to the target service department; and

a third providing module configured to provide, to the target service object, the path along which the target service object moves from the current position to the target service department.

Further, in a further possible implementation of the present application, the queuing service apparatus 30 further comprises:

a fourth determination module configured to determine a service reminding time according to the path along which the target service object moves from the current position to the target service department and the service waiting duration of the target service object; and

a transmission module configured to transmit a service reminder to the target service object at the service reminding time.

Further, in a further possible implementation of the present application, the fourth determination module is specifically configured to:

determine, according to the path along which the target service object moves from the current position to the target service department, a duration in which the target service object moves from the current position to the target service department;

determine a service time of the target service object according to the service waiting duration of the target object and a current time; and

determine the service reminding time according to the service time of the target service object and the duration in which the target service object moves from the current position to the target service department.

In a possible implementation of the present application, the first determination module 33 is specifically configured to:

calculate the service waiting duration of the target service object according to a historical service rate of each service personnel and a difference value between the first service number and the second service number.

Correspondingly, the queuing service apparatus 30 further comprises:

a fourth acquisition module configured to acquire service data of each service personnel in a continuous time period, wherein the service data comprises a number of service objects, a service time of each service object, and a service duration of each service object; and

a fifth determination module configured to calculate, according to the service data of the service personnel in the continuous time period, the historical service rate of the service personnel in respective periods.

Further, in another possible implementation of the present application, the fifth determination module is specifically configured to:

determine an average service duration

$${T}_{x} = \frac{{\sum }_{i = 1}^{D} \frac{t}{{N}_{i}^{x}}}{D}$$

of each service object served by the service personnel in a period X;
where D is a number of service days of the service personnel in the continuous time period, i is an i^{th} service day in the continuous time period, Nᵢ^{X} is a number of service objects served by the service personnel in a period X of the i^{th} service day, and t is a duration of the period X.

Further, in another possible implementation of the present application, the first determination module 33 is further configured to:

determine the service waiting duration of the target service object repeatedly at a preset period.

In the queuing service apparatus according to the embodiment of the present application, the first visiting number of the target patient and the name of the target visiting section may be acquired, the information of each doctor on the day and the second visiting number of the patient who is visiting a doctor in the target visiting section may be determined, then the current visiting waiting duration of the target patient may be determined according to the information of each doctor on the day, the first visiting number and the second visiting number, then the path along which the target patient moves from the current position of the target patient to the target visiting section may be determined according to the current position, the position of the target visiting section and the map data of the hospital, and thereby the current visiting waiting duration and the path along which the target patient moves from the current position to the target visiting section may be provided to the target patient. Therefore, the current visiting waiting duration of the target patient and the path to the target visiting section are determined according to visiting information such as the visiting number, the target visiting section, and the current position etc. of the target patient, and are provided to the target patient, so that the target patient may know the specific visiting waiting duration and the path to the target visiting section, and arrive at the visiting section on time, which not only reduces the visiting waiting duration of the patient and further improves the visiting efficiency, but also saves the human resources and operating costs of the hospital.

In order to implement the above embodiments, the present application further proposes a queuing service device for hospital guide.

FIG. 4 is a schematic structural diagram of a queuing service device 400 according to an embodiment of the present application.

As shown in FIG. 4, the queuing service device 400 comprises:
a memory 410, a processor 420, and a bus 430 for connecting different components (including the memory 410 and the processor 420). The memory 410 has stored thereon a computer program which, when executed by the processor 420, implement the queuing service method according to the embodiment of the present application.

The bus 430 represents one or more of several types of bus structures, including a memory bus or memory controller, a peripheral bus, a graphics acceleration port, a processor, or a local bus using any of a variety of bus structures. For example, these architectures include, but not limited to, an Industry Standard Architecture (ISA) bus, a Micro Channel Architecture (MAC) bus, an enhanced ISA bus, a Video Electronics Standards Association (VESA) local bus and a Peripheral Component Interconnect (PCI) bus.

The queuing service device 400 typically comprises a variety of electronic device readable media. These media may be any available media which can be accessed by the queuing service device 400, including volatile and non-volatile media, and removable and non-removable media.

The memory 410 may further comprise computer system readable media in a form of volatile memory, such as a Random Access Memory (RAM) 440 and/or a cache memory 450. The queuing service device 400 may further comprise other removable/non-removable, and volatile/non-volatile computer system storage media. By way of example only, a storage system 460 may be used to read from and write into non-removable and non-volatile magnetic media (not shown in FIG. 4, commonly referred to as “hard drivers”.) Although not shown in FIG. 4, a magnetic disk driver for reading from and writing into a removable and non-volatile magnetic disk (for example, a “floppy disk”) and an optical disk driver for reading from and writing into a removable and non-volatile optical disk (for example, a Compact Disc Read Only Memory (CD-ROM), a Digital Video Disc Read Only Memory (DVD-ROM), or other optical media.) In these cases, each driver may be connected to the bus 430 via one or more data medium interfaces. The memory 410 may comprise at least one program product having a group of (for example, at least one) program modules which are configured to perform the functions of various embodiments of the present application.

A program/utility 480 having a group of (at least one) program modules 470 may be stored in the memory 410, for example. Such program modules 470 include, but not limited to, an operating system, one or more applications, other program modules and program data, and each or some combination of these examples may include implementations of a network environment. The program modules 470 generally perform the functions and/or methods described in the embodiments of the present application.

The queuing service device 400 may also communicate with one or more external devices 490 (for example, a keyboard, a pointing device, a display 491, etc.), may also communicate with one or more devices which enable a user to interact with the electronic device 400, and/or any device (for example, a network card, a modem etc.) which enables the queuing service device 400 to communicate with one or more other computing devices. This communication may be performed through an Input/Output (I/O) interface 492. Moreover, the device 400 may also communicate with one or more networks (for example, a Local Area Network (LAN), a Wide Area Network (WAN) and/or a public network (for example, the Internet) through a network adapter 493. As shown in FIG. 4, the network adapter 493 communicates with other modules of the queuing service device 400 via the bus 430. It should be appreciated that, although not shown in FIG. 4, other hardware and/or software modules may be used in conjunction with the device 400, including, but not limited to: a microcode, a device driver, a redundant processing unit, an external magnetic disk driving array, a RAID system, a tape driver and a data backup storage system etc.

The processor 420 executes various kinds of functional applications and data processing by executing a program stored in the memory 410.

It should be illustrated that the implementation processes and technical principles of the electronic device according to the present embodiment may be known with reference to the explanation and description of the queuing service method according to the above embodiments of the present application, and will not be described in detail here.

In the queuing service device for hospital guide according to the embodiment of the present application, the queuing service method described above may be performed, to acquire the first visiting number and the name of the target visiting section of the target patient, determine the information of each doctor on the day and the second visiting number of the patient who is visiting a doctor in the target visiting section, then determine the current visiting waiting duration of the target patient according to the information of each doctor on the day, the first visiting number and the second visiting number, and then provide the current visiting waiting duration to the target patient. Therefore, the current visiting waiting duration of the target patient is determined according to information of a doctor corresponding to the target patient, the first visiting number of the target patient, and the second visiting number of the patient who is visiting a doctor, and is provided to the target patient, so that the target patient may know the specific visiting waiting duration and arrive at the visiting section on time, which not only reduces the visiting waiting duration of the patient and improves the visiting efficiency, but also saves the human resources and operating costs of the hospital.

In order to implement the above embodiments, the present application further proposes a computer readable storage medium.

Here, the computer readable storage medium has stored thereon a computer program which, when executed by a processor, implements the queuing service method according to the embodiment of the present application.

In order to implement the above embodiments, the embodiments of the present application further provide a computer program which, when executed by a processor, implements the queuing service method according to the embodiment of the present application.

In an optional implementation, in the present embodiment, the non-transitory computer-readable storage media may employ any combination of one or more computer-readable media. The computer-readable media may be computer-readable signal media or computer-readable storage media. The computer-readable storage media may be, for example but not limited to, an electronic, magnetic, optical, electromagnetic, infrared, or semiconductor system, apparatus, or device, or any combination thereof. More specific examples (non-exhaustive listings) of the computer-readable storage media include electrical connections with one or more wires, a portable computer magnetic disk, a hard disk, a Random Access Memory (RAM), a Read Only Memory (ROM), an Erasable Programmable Read Only Memory (EPROM) or a flash memory, an optical fiber, a portable Compact Disc-Read Only Memory (CD-ROM), an optical storage device, a magnetic memory device, or any suitable combination thereof. The computer readable storage media herein may be any tangible medium which may contain or store a program for use by or in connection with an instruction execution system, apparatus, or device.

The computer readable signal media may include a data signal which propagates in baseband or as a part of a carrier wave, wherein the data signal carries computer readable program codes. The propagated data signal may take a variety of forms including, but not limited to, an electromagnetic signal, an optical signal, or any suitable combination thereof. The computer-readable signal medium may also be any computer-readable medium other than a computer-readable storage medium, which may send, propagate, or transmit programs for use by or in connection with an instruction execution system, apparatus, or device.

The program codes embodied on the computer readable medium may be transmitted using any appropriate medium, including, but not limited to, radio, wire, fiber optic cable, RF, etc., or any suitable combination thereof.

The computer program codes for carrying out operations according to the present application may be written using one or more programming languages, or a combination thereof, including object-oriented programming languages such as Java, Smalltalk, C++, and also including conventional procedural programming languages such as the “C” language or similar programming languages. The program codes may be executed entirely on a user electronic device, may be executed partly on the user electronic device, may be executed as a stand-alone software package, may be executed partly on the user electronic device and partly on a remote electronic device, or may be executed entirely on the remote electronic device or a server. In a case of the remote electronic device, the remote electronic device may be connected to the user electronic device through any kind of network including a Local Area Network (LAN) or a Wide Area Network (WAN), or may be connected to an external electronic device (for example, using an Internet service provider via the Internet).

Other embodiments of the present application will be apparent to those skilled in the art after considering the specification and practicing the embodiments of the present application. The present application aims to cover any variations, uses, or adaptations of the present application, which are in accordance with the general principles of the present application and comprise common knowledge or commonly-used technical means in the art. The specification and embodiments are to be regarded as illustrative only, and the true scope and spirit of the present application are pointed out by the claims.

It is to be understood that the present application is not limited to the accurate structure described above and illustrated in the accompanying drawings, and various amendments and changes may be made without departing from the scope of the present application. The scope of the present application is merely defined by the appended claims.

I/We claim:

1. A queuing service method, comprising:
acquiring a first service number and a target service department of a target service object;
acquiring information of each service personnel and a second service number of a service object who is being served in the target service department;
determining a service waiting duration of the target service object according to the information of each service personnel, the first service number, and the second service number; and
providing the service waiting duration to the target service object.

2. The method according to claim 1, wherein the information of each service personnel is a historical service rate of the service personnel, and determining a service waiting duration of the target service object comprises:
calculating the service waiting duration of the target service object according to the historical service rate of the service personnel and a difference value between the first service number and the second service number.

3. The method according to claim 2, wherein before determining the service waiting duration of the target service object, the method further comprises:
acquiring service data of each service personnel in a continuous time period, wherein the service data comprises a number of service objects, a service time of each of the service objects, and a service duration of each of the service objects; and
calculating, according to the service data of the service personnel in the continuous time period, the historical service rate of the service personnel in respective periods.

4. The method according to claim 3, wherein determining the historical service rate of the service personnel in respective periods comprises:
determining an average service duration
$${T}_{x} = \frac{{\sum }_{i = 1}^{D} \frac{t}{{N}_{i}^{x}}}{D}$$
of each service object served by the service personnel in a period X,
where D is a number of service days of the service personnel in the continuous time period, i is an i^{th} service day in the continuous time period, Nᵢ^{X} is a number of service objects served by the service personnel in a period X of the i^{th} service day, and t is a duration of the period X.

5. The method according to claim 1, further comprising:
determining a recommended service waiting position of the target service object according to a number of service objects in each of service waiting regions and the service waiting duration of the target service object; and
providing the recommended service waiting position to the target service object.

6. The method according to claim 5, wherein before determining the recommended service waiting position of the target service object, the method further comprises:
acquiring identity information of the target service object; and
determining a recommended service waiting position of the target service object comprises:
determining the recommended service waiting position of the target service object according to the identity information of the target service object, the number of service objects in each service waiting region, and the service waiting duration of the target service object.

7. The method according to claim 1, further comprising:
determining, according to a current position of the target service object, a position of the target service department and map data, a path along which the target service object moves from the current position to the target service department; and
providing, to the target service object, the path along which the target service object moves from the current position to the target service department.

8. The method according to claim 7, further comprising:
determining a service reminding time according to the path along which the target service object moves from the current position to the target service department and the service waiting duration of the target service object; and
transmitting a service reminder to the target service object at the service reminding time.

9. The method according to claim 8, wherein determining a service reminding time comprises:
determining, according to the path along which the target service object moves from the current position to the target service department, a duration in which the target service object moves from the current position to the target service department, and determining a service time of the target service object according to the service waiting duration of the target object and a current time; and
determining the service reminding time according to the service time of the target service object and the duration in which the target service object moves from the current position to the target service department.

10. The method according to claim 1, wherein determining the service waiting duration of the target service object comprises:
determining the service waiting duration of the target service object repeatedly at a preset period.

11. A queuing service device, comprising:
a processor; and
a memory connected to the processor, and has stored thereon instructions executed by the processor, wherein the instructions which, when executed by the processor, cause the processor to be configured to:
acquire a first service number and a target service department of a target service object;
acquire information of each service personnel and a second service number of a service object who is being served in the target service department;
determine a service waiting duration of the target service object according to the information of each service personnel, the first service number, and the second service number; and
provide the service waiting duration to the target service object.

12. The device according to claim 11, wherein the processor is further configured to:
calculate the service waiting duration of the target service object according to the historical service rate of the service personnel and a difference value between the first service number and the second service number.

13. The device according to claim 12, wherein the processor is further configured to:
acquire service data of each service personnel in a continuous time period, wherein the service data comprises a number of service objects, a service time of each of the service objects, and a service duration of each of the service objects; and
calculate, according to the service data of the service personnel in the continuous time period, the historical service rate of the service personnel in respective periods.

14. The device according to claim 13, wherein the processor is further configured to:
determine an average service duration
$${T}_{x} = \frac{{\sum }_{i = 1}^{D} \frac{t}{{N}_{i}^{x}}}{D}$$
of each service object served by the service personnel in a period X,
where D is a number of service days of the service personnel in the continuous time period, i is an i^{th} service day in the continuous time period, Nᵢ^{X} is a number of service objects served by the service personnel in a period X of the i^{th} service day, and t is a duration of the period X.

15. The device according to claim 11, wherein the processor is further configured to:
determine a recommended service waiting position of the target service object according to a number of service objects in each of service waiting regions and the service waiting duration of the target service object; and
provide the recommended service waiting position to the target service object.

16. The device according to claim 15, wherein the processor is further configured to:
acquire identity information of the target service object; and
determine the recommended service waiting position of the target service object according to the identity information of the target service object, the number of service objects in each service waiting region, and the service waiting duration of the target service object.

17. The device according to claim 11, wherein the processor is further configured to:
determine, according to a current position of the target service object, a position of the target service department and map data, a path along which the target service object moves from the current position to the target service department; and
provide, to the target service object, the path along which the target service object moves from the current position to the target service department.

18. The device according to claim 17, wherein the processor is further configured to:
determine a service reminding time according to the path along which the target service object moves from the current position to the target service department and the service waiting duration of the target service object; and
transmit a service reminder to the target service object at the service reminding time.

19. The device according to claim 18, wherein the processor is further configured to:
determine, according to the path along which the target service object moves from the current position to the target service department, a duration in which the target service object moves from the current position to the target service department, and determine a service time of the target service object according to the service waiting duration of the target object and a current time; and
determine the service reminding time according to the service time of the target service object and the duration in which the target service object moves from the current position to the target service department.

20. A computer readable storage medium having stored thereon a computer program, wherein the program, when executed by a processor, implements the queuing service method according to claim 1.
